(19) United States
(12) Patent Application Publication
(10) Pub. No.: US 2026/0112288 A1
(43) Pub. Date: Apr. 23, 2026

(54) SYSTEM

(71) Applicant: SoftBank Group Corp., Tokyo (JP)

(72) Inventor: Hiromichi KAGEYAMA, Tokyo (JP)

(21) Appl. No.: 19/354,302

(22) Filed: Oct. 9, 2025

(30) Foreign Application Priority Data
Oct. 18, 2024 (JP) 2024-183651

(51) Int. Cl. G09B 15/00; G06V 20/20; G06V 20/40; G06V 40/20; G09B 5/02

(52) U.S. Cl. CPC G09B 15/00; G06V 20/20; G06V 20/41; G06V 40/28; G09B 5/02

(57) ABSTRACT

The system according to the embodiment includes an acquisition unit, an analysis unit, a generation unit, a provision unit, and an evaluation unit. The acquisition unit acquires physique data. The analysis unit analyzes the physique data acquired by the acquisition unit. The generation unit generates an optimal playing form and fingering method based on the data analyzed by the analysis unit. The provision unit provides feedback generated by the generation unit. The evaluation unit evaluates user progress based on the feedback provided by the provision unit and proposes new practice methods or tasks.

### CROSS-REFERENCE TO RELATED APPLICATION

The present application claims priority to and incorporates by reference the entire contents of Japanese Patent Application No. 2024-183651 filed in Japan on Oct. 18, 2024.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, including: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult for musical instrument beginners to find practice methods suited to their own physique or finger length, making it difficult to receive individually optimized instruction.

### SUMMARY OF THE INVENTION

The system according to the embodiment includes an acquisition unit, an analysis unit, a generation unit, a provision unit, and an evaluation unit. The acquisition unit acquires physique data. The analysis unit analyzes the physique data acquired by the acquisition unit. The generation unit generates an optimal playing form and fingering method based on the data analyzed by the analysis unit. The provision unit provides feedback generated by the generation unit. The evaluation unit evaluates user progress based on the feedback provided by the provision unit and proposes new practice methods or tasks.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor with a sign (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) with a sign is a memory where information is temporarily stored and used as a work memory by the processor.

In the following embodiments, a storage with a sign is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) with a sign is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,”the same concept as “A and/or B”applies.

### First Embodiment

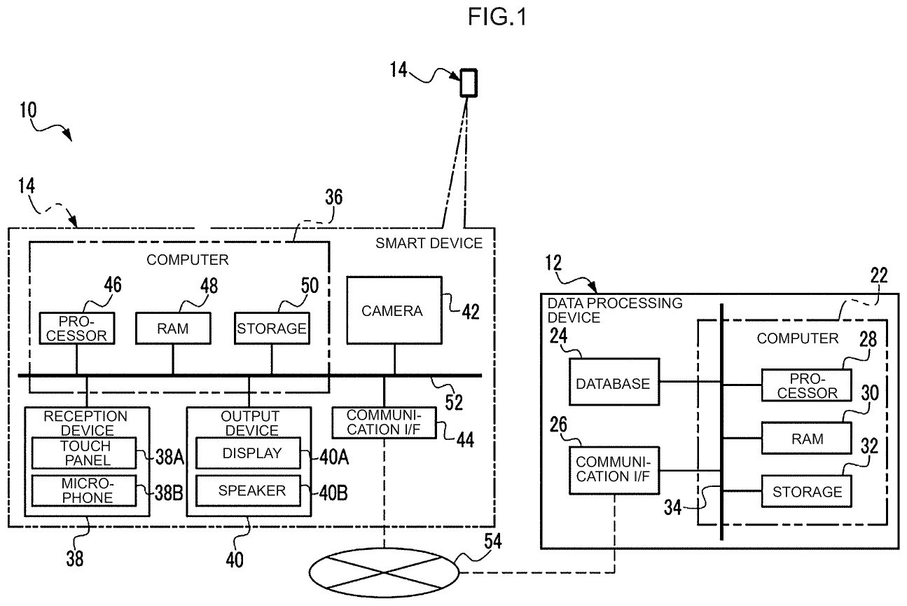

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52.

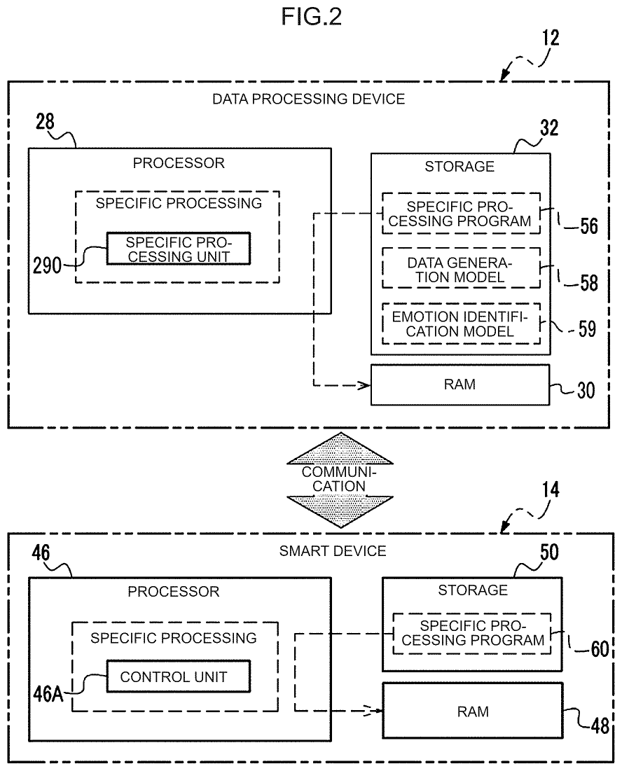

The reception device 38 includes a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 includes a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### [Example 1 of Embodiment]

The personalized play coach according to the embodiment of the present invention is an AI system for solving the problems of beginners and intermediate players of musical instruments. Many beginners cannot find practice methods suited to their personal characteristics such as physique or finger length and often give up. For example, the episode “I gave up on guitar because I couldn't press the F chord” is often heard. Although it is possible to attend a music school and receive instruction, whether individually optimized instruction can be received depends on the skill and experience of the instructor, and is a matter of luck. The personalized play coach uses multimodal generative AI to provide individualized instruction on the optimal playing style and fingering method for each player based on information such as the user's physique and finger length. This solves problems such as “holding the instrument in a way that burdens the body and causes tendonitis” or “fingers cannot reach or move well,” and rescues beginners who tend to give up at the entry point of musical performance. For intermediate players who tend to develop bad habits, comprehensive corrective instruction is possible, taking into account skeletal structure and joint range of motion. For example, the user photographs their own physique using a smartphone camera, and the generative AI automatically analyzes physique features such as height, limb length, and joint positions to generate a user-specific profile. Next, when the user records a video of themselves playing an instrument with a smartphone, the generative AI analyzes the recorded video and compares it with ideal playing forms and fingering methods. Based on the analysis results from the generative AI, specific feedback is generated. This feedback is displayed superimposed in AR on the user's performance, making it intuitively understandable. In addition, the generative AI periodically evaluates the user's progress and proposes new practice methods or tasks according to the skill level. As a result, even after beginners acquire basic skills, advanced feedback and performance tasks for intermediate players can continue to be provided. The personalized play coach prevents beginners from giving up and supports the continuation of musical performance by providing individually optimized instruction, always-available support, and efficient skill improvement opportunities. This allows users to practice in a way that suits their own challenges and pace, and to experience the enjoyment of playing musical instruments. Thus, the personalized play coach enables individually optimized instruction by providing optimal playing forms and fingering methods based on the user's physique data and evaluating progress.

The personalized play coach according to the embodiment includes an acquisition unit, an analysis unit, a generation unit, a provision unit, and an evaluation unit. The acquisition unit acquires the user's physique data. The acquisition unit can, for example, acquire the user's physique data using a smartphone camera. The acquisition unit automatically analyzes physique features such as the user's height, limb length, and joint positions. The analysis unit analyzes the physique data acquired by the acquisition unit. The analysis unit can, for example, generate a user-specific profile based on the acquired physique data. The analysis unit analyzes the user's physique data in detail and generates basic data for providing individually optimized instruction. The generation unit generates an optimal playing form and fingering method based on the data analyzed by the analysis unit. The generation unit can, for example, analyze a user's performance video and generate an ideal playing form and fingering method. The generation unit uses generative AI to analyze the user's performance video and generate an optimal playing form and fingering method. The provision unit provides feedback generated by the generation unit. The provision unit can, for example, display feedback generated by generative AI superimposed in AR on the user's performance. The provision unit uses AR technology to display feedback so that the user can intuitively understand the feedback. The evaluation unit evaluates user progress based on the feedback provided by the provision unit and proposes new practice methods or tasks. The evaluation unit can, for example, periodically evaluate user progress and propose new practice methods or tasks according to the skill level. The evaluation unit evaluates progress in detail to provide appropriate practice methods or tasks according to the user's skill level. Thus, the personalized play coach according to the embodiment enables individually optimized instruction by providing optimal playing forms and fingering methods based on the user's physique data and evaluating progress.

The acquisition unit acquires the user's physique data. The acquisition unit can, for example, acquire the user's physique data using a smartphone camera. Specifically, the user's entire body is photographed using the smartphone camera, and image processing technology is used to automatically analyze physique features such as height, limb length, and joint positions. This utilizes image recognition algorithms based on deep learning, enabling highly accurate acquisition of the user's physique data. For example, the user stands in front of the smartphone camera and takes a specific pose, allowing the acquisition unit to take images from multiple angles and generate a 3D model. Based on this 3D model, the user's physique data can be analyzed in detail. In addition, the acquisition unit can also acquire data from wearable devices that the user uses daily. For example, data such as heart rate, step count, and calories burned can be collected from smartwatches or fitness trackers and integrated with the user's physique data to create a more comprehensive profile. Thus, the acquisition unit can collect the user's physique data from multiple perspectives and provide detailed and accurate data.

The analysis unit analyzes the physique data acquired by the acquisition unit. The analysis unit can, for example, generate a user-specific profile based on the acquired physique data. Specifically, the data sent from the acquisition unit is analyzed to obtain a detailed understanding of the user's physique features. This includes a process of classifying the user's physique data and extracting feature values using machine learning algorithms. For example, based on data such as the user's height, limb length, and joint positions, basic data for identifying the optimal playing form and fingering method for the user's physique is generated. The analysis unit uses these data to create a profile for providing individually optimized instruction according to the user's physique. This profile includes not only the user's physique features but also past performance data and practice history. Thus, the analysis unit can analyze the user's physique data in detail and generate basic data for providing individually optimized instruction. Furthermore, the analysis unit can continuously monitor the user's physique data and update the profile as necessary. This enables the analysis unit to always provide optimal instruction based on the latest data.

The generation unit generates an optimal playing form and fingering method based on the data analyzed by the analysis unit. The generation unit can, for example, analyze a user's performance video and generate an ideal playing form and fingering method. Specifically, generative AI is used to analyze the user's performance video and generate an optimal playing form and fingering method. The generative AI utilizes video analysis technology based on deep learning to analyze the user's performance movements in detail. For example, the hand movements, finger positions, and body posture when the user plays an instrument are analyzed to identify the ideal playing form and fingering method. The generation unit can generate an optimal playing form and fingering method suited to the user's physique and playing style based on these data. Furthermore, the generation unit generates feedback for providing the generated playing form and fingering method to the user. This includes specific performance guidance and suggestions for practice methods. For example, feedback can be generated to suggest practice methods for improving specific performance techniques or to indicate specific points for improvement in playing form. Thus, the generation unit can generate an optimal playing form and fingering method suited to the user's physique and playing style and provide individually optimized instruction.

The provision unit provides feedback generated by the generation unit. The provision unit can, for example, display feedback generated by generative AI superimposed in AR on the user's performance. Specifically, AR technology is used to superimpose feedback in real time on the user's performance video. This allows the user to intuitively understand which parts to improve while watching their own performance. For example, when the user is playing an instrument, feedback can be displayed in real time on hand positions and finger movements, indicating the correct playing form and fingering method. The provision unit can use visual guides or animations to make it easier for the user to intuitively understand the feedback. This makes it easier for the user to grasp specific points for improvement while watching their own performance. In addition, the provision unit can record the user's response to feedback and reflect it in the next feedback. This enables the provision unit to provide appropriate feedback according to the user's progress and realize individually optimized instruction. Furthermore, the provision unit can flexibly adjust the feedback display method according to the environment or device when the user receives feedback. For example, feedback display can be provided for various devices such as smartphones, tablets, and AR glasses. Thus, the provision unit enables the user to receive optimal feedback in any environment.

The evaluation unit evaluates user progress based on the feedback provided by the provision unit and proposes new practice methods or tasks. Specifically, the evaluation unit analyzes the user's performance data and feedback history to evaluate the user's skill level and progress in detail. This includes a process of analyzing the user's performance data using machine learning algorithms to evaluate skill improvement and task achievement. For example, it is possible to evaluate how much time the user spent to master a specific performance technique and how accurately the user can now perform it. The evaluation unit uses these data to propose new practice methods or tasks according to the user's skill level. For example, it can specifically indicate practice methods for improving specific performance techniques or tasks to be mastered next. Furthermore, the evaluation unit periodically evaluates user progress and provides feedback to support continuous skill improvement. Thus, the evaluation unit can provide appropriate practice methods or tasks according to the user's skill level and realize individually optimized instruction. In addition, the evaluation unit can record the user's response to feedback and reflect it in the next evaluation to perform more accurate evaluation. This enables the evaluation unit to evaluate user progress in detail and generate basic data for providing individually optimized instruction.

The provision unit can display feedback generated by generative AI superimposed in AR on the user's performance. The provision unit can, for example, have the generative AI analyze the user's performance video, generate an ideal playing form and fingering method, and display the feedback in AR. The provision unit uses AR technology to display feedback so that the user can intuitively understand the feedback. For example, the provision unit can visually display the ideal playing form and fingering method superimposed on the user's performance video. This allows the user to practice while comparing their own performance with the ideal playing form. Some or all of the above-described processing in the provision unit may be performed using generative AI or may be performed without using generative AI. For example, the provision unit can use a system that takes feedback generated by generative AI as input and outputs AR display to display the feedback. This makes it easier for the user to intuitively understand the feedback.

The evaluation unit can periodically evaluate user progress and propose new practice methods or tasks according to the skill level. The evaluation unit can, for example, periodically analyze the user's performance video and evaluate progress. The evaluation unit proposes appropriate practice methods or tasks according to the user's skill level. For example, the evaluation unit can propose basic practice methods for beginners. The evaluation unit can also propose advanced practice methods or tasks for intermediate players. The evaluation unit evaluates user progress in detail and provides appropriate feedback according to the skill level. This allows the user to receive practice methods or tasks according to their skill level and efficiently improve their skills. Some or all of the above-described processing in the evaluation unit may be performed using AI or may be performed without using AI. For example, the evaluation unit can input the user's performance video to AI and have the AI perform progress evaluation. This enables the provision of appropriate practice methods or tasks according to the user's skill level.

The acquisition unit can acquire the user's physique data using a smartphone camera. The acquisition unit can, for example, have the user photograph their own physique with a smartphone camera and acquire the data. The acquisition unit automatically analyzes physique features such as the user's height, limb length, and joint positions using the smartphone camera. The acquisition unit provides a simple method using a smartphone camera so that the user can easily acquire physique data. For example, the acquisition unit can analyze image data photographed by the smartphone camera and extract physique data. This allows the user to easily acquire physique data without the need for special equipment. Some or all of the above-described processing in the acquisition unit may be performed using AI or may be performed without using AI. For example, the acquisition unit can input image data photographed by the smartphone camera to AI and have the AI perform physique data analysis. This allows the user to easily acquire physique data.

The analysis unit can generate a user-specific profile based on the acquired physique data. The analysis unit can, for example, analyze the acquired physique data in detail and generate a user-specific profile. The analysis unit generates basic data for providing individually optimized instruction based on the user's physique data. For example, the analysis unit analyzes physique features such as the user's height, limb length, and joint positions and generates a user-specific profile. This allows the user to receive an optimal playing form and fingering method suited to their own physique. Some or all of the above-described processing in the analysis unit may be performed using AI or may be performed without using AI. For example, the analysis unit can input the acquired physique data to AI and have the AI generate the user-specific profile. This enables the generation of a user-specific profile and individually optimized instruction.

The generation unit can analyze a user's performance video and generate an ideal playing form and fingering method. The generation unit can, for example, input the user's performance video to generative AI and have the generative AI generate the ideal playing form and fingering method. The generation unit uses generative AI to analyze the user's performance video and generate an optimal playing form and fingering method. For example, the generation unit can analyze the user's performance video in detail and generate an ideal playing form and fingering method. This allows the user to practice while comparing their own performance with the ideal playing form. Some or all of the above-described processing in the generation unit may be performed using generative AI or may be performed without using generative AI. For example, the generation unit can input the user's performance video to generative AI and have the generative AI generate the ideal playing form and fingering method. This enables the provision of ideal playing forms and fingering methods by analyzing the user's performance video.

The acquisition unit can analyze the user's past physique data and select an optimal acquisition method. The acquisition unit can, for example, select the method that obtained the most accurate data based on the user's past physique data. The acquisition unit can also analyze fluctuations in the user's past physique data and select a stable data acquisition method. The acquisition unit can also consider the frequency of acquisition of the user's past physique data and select the optimal acquisition timing. This allows physique data to be acquired by the optimal method based on past data. Some or all of the above-described processing in the acquisition unit may be performed using AI or may be performed without using AI. For example, the acquisition unit can input the user's past physique data to AI and have the AI select the optimal acquisition method. This allows physique data to be acquired by the optimal method based on past data.

The acquisition unit can perform filtering based on the user's current health condition and lifestyle habits when acquiring physique data. The acquisition unit can, for example, consider the user's current health condition and acquire physique data when the user is in good condition. The acquisition unit can also analyze the user's lifestyle habits and acquire physique data at the most suitable time of day. The acquisition unit can also select the type of data to be acquired based on the user's health condition and lifestyle habits. This allows data to be acquired according to the user's health condition and lifestyle habits. Some or all of the above-described processing in the acquisition unit may be performed using AI or may be performed without using AI. For example, the acquisition unit can input the user's health data to AI and have the AI perform filtering. This allows data to be acquired according to the user's health condition and lifestyle habits.

The acquisition unit can consider the user's geographic location information when acquiring physique data and preferentially acquire highly relevant data. The acquisition unit can, for example, preferentially acquire data related to oxygen concentration and atmospheric pressure when the user is at high altitude. The acquisition unit can also preferentially acquire data related to environmental noise and vibration when the user is in an urban area. The acquisition unit can also preferentially acquire data related to indoor temperature and humidity when the user is indoors. This allows highly relevant data to be acquired based on the user's geographic location information. Some or all of the above-described processing in the acquisition unit may be performed using AI or may be performed without using AI. For example, the acquisition unit can input the user's geographic location data to AI and have the AI acquire highly relevant data. This allows highly relevant data to be acquired based on the user's geographic location information.

The acquisition unit can analyze the user's social media activity when acquiring physique data and acquire relevant data. The acquisition unit can, for example, acquire physique data related to the activity if the user posts about exercise on social media. The acquisition unit can also acquire physique data based on information shared by the user about health on social media. The acquisition unit can also acquire physique data related to specific events if the user participates in such events on social media. This allows relevant data to be acquired based on the user's social media activity. Some or all of the above-described processing in the acquisition unit may be performed using AI or may be performed without using AI. For example, the acquisition unit can input the user's social media data to AI and have the AI acquire relevant data. This allows relevant data to be acquired based on the user's social media activity.

The analysis unit can adjust the level of detail of analysis based on the importance of the physique data during analysis. The analysis unit can, for example, perform detailed analysis for important physique data. The analysis unit can also perform simplified analysis for basic physique data. The analysis unit can also perform detailed analysis according to the purpose for physique data related to a specific purpose. This allows detailed analysis to be performed for important data. Some or all of the above-described processing in the analysis unit may be performed using AI or may be performed without using AI. For example, the analysis unit can input physique data to AI and have the AI adjust the level of detail of analysis based on importance. This allows detailed analysis to be performed for important data.

The analysis unit can apply different analysis algorithms according to the category of the physique data during analysis. The analysis unit can, for example, apply a skeletal analysis algorithm to skeletal data. The analysis unit can also apply a muscle analysis algorithm to muscle data. The analysis unit can also apply a joint analysis algorithm to joint data. This allows appropriate analysis to be performed according to the category of data. Some or all of the above-described processing in the analysis unit may be performed using AI or may be performed without using AI. For example, the analysis unit can input physique data to AI and have the AI apply analysis algorithms according to the category. This allows appropriate analysis to be performed according to the category of data.

The analysis unit can determine the priority of analysis based on the acquisition timing of the physique data during analysis. The analysis unit can, for example, preferentially analyze the latest physique data. The analysis unit can also analyze the latest data while referring to past physique data. The analysis unit can also preferentially analyze physique data acquired during a specific period. This allows the latest data to be preferentially analyzed. Some or all of the above-described processing in the analysis unit may be performed using AI or may be performed without using AI. For example, the analysis unit can input physique data to AI and have the AI determine the priority of analysis based on acquisition timing. This allows the latest data to be preferentially analyzed.

The analysis unit can adjust the order of analysis based on the relevance of the physique data during analysis. The analysis unit can, for example, preferentially analyze important physique data. The analysis unit can also preferentially analyze highly relevant physique data. The analysis unit can also preferentially analyze physique data related to a specific purpose. This allows highly relevant data to be preferentially analyzed. Some or all of the above-described processing in the analysis unit may be performed using AI or may be performed without using AI. For example, the analysis unit can input physique data to AI and have the AI adjust the order of analysis based on relevance. This allows highly relevant data to be preferentially analyzed.

The generation unit can adjust the level of detail of generation based on the importance of the physique data during generation. The generation unit can, for example, generate detailed playing forms and fingering methods based on important physique data. The generation unit can also generate simplified playing forms and fingering methods based on basic physique data. The generation unit can also generate detailed playing forms and fingering methods according to the purpose based on physique data related to a specific purpose. This allows detailed playing forms and fingering methods to be generated based on important data. Some or all of the above-described processing in the generation unit may be performed using AI or may be performed without using AI. For example, the generation unit can input physique data to AI and have the AI adjust the level of detail of generation based on importance. This allows detailed playing forms and fingering methods to be generated based on important data.

The generation unit can apply different generation algorithms according to the category of the physique data during generation. The generation unit can, for example, generate playing forms and fingering methods suitable for the skeleton based on skeletal data. The generation unit can also generate playing forms and fingering methods suitable for muscles based on muscle data. The generation unit can also generate playing forms and fingering methods suitable for joints based on joint data. This allows appropriate playing forms and fingering methods to be generated according to the category of data. Some or all of the above-described processing in the generation unit may be performed using AI or may be performed without using AI. For example, the generation unit can input physique data to AI and have the AI apply generation algorithms according to the category. This allows appropriate playing forms and fingering methods to be generated according to the category of data.

The generation unit can determine the priority of generation based on the acquisition timing of the physique data during generation. The generation unit can, for example, generate playing forms and fingering methods based on the latest physique data. The generation unit can also generate playing forms and fingering methods based on the latest data while referring to past physique data. The generation unit can also generate playing forms and fingering methods based on physique data acquired during a specific period. This allows playing forms and fingering methods to be generated based on the latest data. Some or all of the above-described processing in the generation unit may be performed using AI or may be performed without using AI. For example, the generation unit can input physique data to AI and have the AI determine the priority of generation based on acquisition timing. This allows playing forms and fingering methods to be generated based on the latest data.

The generation unit can adjust the order of generation based on the relevance of the physique data during generation. The generation unit can, for example, preferentially generate playing forms and fingering methods based on important physique data. The generation unit can also preferentially generate playing forms and fingering methods based on highly relevant physique data. The generation unit can also preferentially generate playing forms and fingering methods based on physique data related to a specific purpose. This allows playing forms and fingering methods to be preferentially generated based on highly relevant data. Some or all of the above-described processing in the generation unit may be performed using AI or may be performed without using AI. For example, the generation unit can input physique data to AI and have the AI adjust the order of generation based on relevance. This allows playing forms and fingering methods to be preferentially generated based on highly relevant data.

The provision unit can refer to the user's past feedback history when providing feedback and select an optimal display method. The provision unit can, for example, select the most effective display method based on the user's past feedback history. The provision unit can also analyze the user's past feedback history and select an easy-to-understand display method. The provision unit can also adjust the display order of feedback with reference to the user's past feedback history. This allows the optimal display method to be selected based on past feedback history. Some or all of the above-described processing in the provision unit may be performed using AI or may be performed without using AI. For example, the provision unit can input the user's feedback history to AI and have the AI select the optimal display method. This allows the optimal display method to be selected based on past feedback history.

The provision unit can customize the content of feedback based on the user's current performance status when providing feedback. The provision unit can, for example, analyze the user's current performance status and provide appropriate feedback. The provision unit can also adjust the level of detail of feedback according to the user's performance status. The provision unit can also determine the priority of feedback based on the user's performance status. This allows appropriate feedback to be provided according to the current performance status. Some or all of the above-described processing in the provision unit may be performed using AI or may be performed without using AI. For example, the provision unit can input the user's performance data to AI and have the AI customize the feedback. This allows appropriate feedback to be provided according to the current performance status.

The provision unit can consider the user's geographic location information when providing feedback and select an optimal feedback method. The provision unit can, for example, preferentially provide visual feedback when the user is outdoors. The provision unit can also provide detailed feedback when the user is indoors. The provision unit can also provide concise and focused feedback when the user is on the move. This allows the optimal feedback method to be selected based on geographic location information. Some or all of the above-described processing in the provision unit may be performed using AI or may be performed without using AI. For example, the provision unit can input the user's geographic location data to AI and have the AI select the optimal feedback method. This allows the optimal feedback method to be selected based on geographic location information.

The provision unit can analyze the user's social media activity when providing feedback and propose feedback means. The provision unit can, for example, provide feedback related to the activity if the user posts about exercise on social media. The provision unit can also provide feedback based on information shared by the user about health on social media. The provision unit can also provide feedback related to specific events if the user participates in such events on social media. This allows appropriate feedback means to be proposed based on social media activity. Some or all of the above-described processing in the provision unit may be performed using AI or may be performed without using AI. For example, the provision unit can input the user's social media data to AI and have the AI propose feedback means. This allows appropriate feedback means to be proposed based on social media activity.

The evaluation unit can analyze the user's past performance data during evaluation and select an optimal evaluation method. The evaluation unit can, for example, select the most effective evaluation method based on the user's past performance data. The evaluation unit can also analyze the user's past performance data and select an easy-to-understand evaluation method. The evaluation unit can also adjust the display order of evaluation with reference to the user's past performance data. This allows the optimal evaluation method to be selected based on past performance data. Some or all of the above-described processing in the evaluation unit may be performed using AI or may be performed without using AI. For example, the evaluation unit can input the user's performance data to AI and have the AI select the optimal evaluation method. This allows the optimal evaluation method to be selected based on past performance data.

The evaluation unit can customize evaluation criteria based on the user's current skill level during evaluation. The evaluation unit can, for example, analyze the user's current skill level and set appropriate evaluation criteria. The evaluation unit can also adjust the level of detail of evaluation according to the user's skill level. The evaluation unit can also determine the priority of evaluation based on the user's skill level. This allows appropriate evaluation criteria to be set according to the current skill level. Some or all of the above-described processing in the evaluation unit may be performed using AI or may be performed without using AI. For example, the evaluation unit can input the user's skill data to AI and have the AI customize the evaluation criteria. This allows appropriate evaluation criteria to be set according to the current skill level.

The evaluation unit can consider the user's geographic location information during evaluation and select an optimal evaluation method. The evaluation unit can, for example, preferentially provide visual evaluation when the user is outdoors. The evaluation unit can also provide detailed evaluation when the user is indoors. The evaluation unit can also provide concise and focused evaluation when the user is on the move. This allows the optimal evaluation method to be selected based on geographic location information. Some or all of the above-described processing in the evaluation unit may be performed using AI or may be performed without using AI. For example, the evaluation unit can input the user's geographic location data to AI and have the AI select the optimal evaluation method. This allows the optimal evaluation method to be selected based on geographic location information.

The evaluation unit can analyze the user's social media activity during evaluation and propose evaluation means. The evaluation unit can, for example, provide evaluation related to the activity if the user posts about exercise on social media. The evaluation unit can also provide evaluation based on information shared by the user about health on social media. The evaluation unit can also provide evaluation related to specific events if the user participates in such events on social media. This allows appropriate evaluation means to be proposed based on social media activity. Some or all of the above-described processing in the evaluation unit may be performed using AI or may be performed without using AI. For example, the evaluation unit can input the user's social media data to AI and have the AI propose evaluation means. This allows appropriate evaluation means to be proposed based on social media activity.

The system according to the embodiment is not limited to the above examples and can be variously modified, for example, as follows.

The acquisition unit can acquire, in addition to the user's physique data, the user's lifestyle data. For example, data such as the user's sleep patterns, dietary content, and exercise habits are acquired, and the user's physical condition and energy level are estimated based on these data. The analysis unit can generate an optimal practice schedule considering the user's physical condition and energy level based on the acquired lifestyle data. The generation unit generates practice content according to the user's physical condition and energy level based on the analysis results. The provision unit provides the generated practice content to the user and supports the user to continue practicing without difficulty. This enables individually optimized instruction according to the user's lifestyle.

The evaluation unit can analyze the user's past practice data and select an optimal evaluation method. For example, the evaluation unit selects the most effective evaluation method based on the user's past practice data. The evaluation unit can also analyze the user's past practice data and select an easy-to-understand evaluation method. The evaluation unit can also adjust the display order of evaluation with reference to the user's past practice data. This allows the optimal evaluation method to be selected based on past practice data. Some or all of the above-described processing in the evaluation unit may be performed using AI or may be performed without using AI. For example, the evaluation unit can input the user's practice data to AI and have the AI select the optimal evaluation method. This allows the optimal evaluation method to be selected based on past practice data.

The acquisition unit can acquire, in addition to the user's physique data, the user's health data. For example, data such as the user's heart rate, blood pressure, and body temperature are acquired, and the user's health condition is estimated based on these data. The analysis unit can generate an optimal practice schedule considering the user's health condition based on the acquired health data. The generation unit generates practice content according to the user's health condition based on the analysis results. The provision unit provides the generated practice content to the user and supports the user to continue practicing without difficulty. This enables individually optimized instruction according to the user's health condition.

The generation unit can analyze, in addition to the user's performance video, the user's audio data and generate an optimal playing form and fingering method. For example, the user's audio data during performance is acquired, and the strength of sound and accuracy of rhythm are analyzed. The generation unit can adjust the user's playing form and fingering method based on the analysis results of the audio data. The provision unit provides the generated playing form and fingering method to the user and supports the user in improving musical expressiveness. This enables individually optimized instruction utilizing audio data.

The evaluation unit can perform evaluation considering, in addition to the user's performance data, the user's musical preferences and goals. For example, the user's preferred music genre and target performance style are acquired, and evaluation criteria are set based on this information. The evaluation unit can adjust the level of detail of evaluation and the content of feedback according to the user's musical preferences and goals. This allows appropriate evaluation to be provided according to the user's individual goals. Some or all of the above-described processing in the evaluation unit may be performed using AI or may be performed without using AI. For example, the evaluation unit can input the user's musical preferences and goal data to AI and have the AI set the evaluation criteria. This allows appropriate evaluation to be provided according to the user's musical preferences and goals.

The acquisition unit can acquire, in addition to the user's physique data, the user's geographic location information. For example, when the user is at high altitude, data related to oxygen concentration and atmospheric pressure are acquired. When the user is in an urban area, data related to environmental noise and vibration can also be acquired. When the user is indoors, data related to indoor temperature and humidity can also be acquired. This allows highly relevant data to be acquired based on the user's geographic location information. Some or all of the above-described processing in the acquisition unit may be performed using AI or may be performed without using AI. For example, the acquisition unit can input the user's geographic location data to AI and have the AI acquire highly relevant data. This allows highly relevant data to be acquired based on the user's geographic location information.

The flow of processing in Example 1 of the Embodiment will be briefly described below.
Step 1: The acquisition unit acquires the user's physique data. The acquisition unit can, for example, acquire the user's physique data using a smartphone camera. The acquisition unit automatically analyzes physique features such as the user's height, limb length, and joint positions.
Step 2: The analysis unit analyzes the physique data acquired by the acquisition unit. The analysis unit can, for example, generate a user-specific profile based on the acquired physique data. The analysis unit analyzes the user's physique data in detail and generates basic data for providing individually optimized instruction.
Step 3: The generation unit generates an optimal playing form and fingering method based on the data analyzed by the analysis unit. The generation unit can, for example, analyze a user's performance video and generate an ideal playing form and fingering method. The generation unit uses generative AI to analyze the user's performance video and generate an optimal playing form and fingering method.
Step 4: The provision unit provides feedback generated by the generation unit. The provision unit can, for example, display feedback generated by generative AI superimposed in AR on the user's performance. The provision unit uses AR technology to display feedback so that the user can intuitively understand the feedback.
Step 5: The evaluation unit evaluates user progress based on the feedback provided by the provision unit and proposes new practice methods or tasks. The evaluation unit can, for example, periodically evaluate user progress and propose new practice methods or tasks according to the skill level. The evaluation unit evaluates progress in detail to provide appropriate practice methods or tasks according to the user's skill level.

### [Example 2 of Embodiment]

The personalized play coach according to the embodiment of the present invention is an AI system for solving the problems of beginners and intermediate players of musical instruments. Many beginners cannot find practice methods suited to their personal characteristics such as physique or finger length and often give up. For example, the episode “I gave up on guitar because I couldn't press the F chord” is often heard. Although it is possible to attend a music school and receive instruction, whether individually optimized instruction can be received depends on the skill and experience of the instructor, and is a matter of luck. The personalized play coach uses multimodal generative AI to provide individualized instruction on the optimal playing style and fingering method for each player based on information such as the user's physique and finger length. This solves problems such as “holding the instrument in a way that burdens the body and causes tendonitis” or “fingers cannot reach or move well,” and rescues beginners who tend to give up at the entry point of musical performance. For intermediate players who tend to develop bad habits, comprehensive corrective instruction is possible, taking into account skeletal structure and joint range of motion. For example, the user photographs their own physique using a smartphone camera, and the generative AI automatically analyzes physique features such as height, limb length, and joint positions to generate a user-specific profile. Next, when the user records a video of themselves playing an instrument with a smartphone, the generative AI analyzes the recorded video and compares it with ideal playing forms and fingering methods. Based on the analysis results from the generative AI, specific feedback is generated. This feedback is displayed superimposed in AR on the user's performance, making it intuitively understandable. In addition, the generative AI periodically evaluates the user's progress and proposes new practice methods or tasks according to the skill level. As a result, even after beginners acquire basic skills, advanced feedback and performance tasks for intermediate players can continue to be provided. The personalized play coach prevents beginners from giving up and supports the continuation of musical performance by providing individually optimized instruction, always-available support, and efficient skill improvement opportunities. This allows users to practice in a way that suits their own challenges and pace, and to experience the enjoyment of playing musical instruments. Thus, the personalized play coach enables individually optimized instruction by providing optimal playing forms and fingering methods based on the user's physique data and evaluating progress.

The personalized play coach according to the embodiment comprises an acquisition unit, an analysis unit, a generation unit, a provision unit, and an evaluation unit. The acquisition unit acquires the user's physique data. The acquisition unit can, for example, acquire the user's physique data using a smartphone camera. The acquisition unit automatically analyzes physique features such as the user's height, limb length, and joint positions. The analysis unit analyzes the physique data acquired by the acquisition unit. The analysis unit can, for example, generate a user-specific profile based on the acquired physique data. The analysis unit analyzes the user's physique data in detail and generates basic data for providing individually optimized instruction. The generation unit generates an optimal playing form and fingering method based on the data analyzed by the analysis unit. The generation unit can, for example, analyze a user's performance video and generate an ideal playing form and fingering method. The generation unit uses generative AI to analyze the user's performance video and generate an optimal playing form and fingering method. The provision unit provides feedback generated by the generation unit. The provision unit can, for example, display feedback generated by generative AI superimposed in AR on the user's performance. The provision unit uses AR technology to display feedback so that the user can intuitively understand the feedback. The evaluation unit evaluates user progress based on the feedback provided by the provision unit and proposes new practice methods or tasks. The evaluation unit can, for example, periodically evaluate user progress and propose new practice methods or tasks according to the skill level. The evaluation unit evaluates progress in detail to provide appropriate practice methods or tasks according to the user's skill level. Thus, the personalized play coach according to the embodiment enables individually optimized instruction by providing optimal playing forms and fingering methods based on the user's physique data and evaluating progress.

The acquisition unit acquires the user's physique data. The acquisition unit can, for example, acquire the user's physique data using a smartphone camera. Specifically, the user's entire body is photographed using the smartphone camera, and image processing technology is used to automatically analyze physique features such as height, limb length, and joint positions. This utilizes image recognition algorithms based on deep learning, enabling highly accurate acquisition of the user's physique data. For example, the user stands in front of the smartphone camera and takes a specific pose, allowing the acquisition unit to take images from multiple angles and generate a 3D model. Based on this 3D model, the user's physique data can be analyzed in detail. In addition, the acquisition unit can also acquire data from wearable devices that the user uses daily. For example, data such as heart rate, step count, and calories burned can be collected from smartwatches or fitness trackers and integrated with the user's physique data to create a more comprehensive profile. Thus, the acquisition unit can collect the user's physique data from multiple perspectives and provide detailed and accurate data.

The analysis unit analyzes the physique data acquired by the acquisition unit. The analysis unit can, for example, generate a user-specific profile based on the acquired physique data. Specifically, the data sent from the acquisition unit is analyzed to obtain a detailed understanding of the user's physique features. This includes a process of classifying the user's physique data and extracting feature values using machine learning algorithms. For example, based on data such as the user's height, limb length, and joint positions, basic data for identifying the optimal playing form and fingering method for the user's physique is generated. The analysis unit uses these data to create a profile for providing individually optimized instruction according to the user's physique. This profile includes not only the user's physique features but also past performance data and practice history. Thus, the analysis unit can analyze the user's physique data in detail and generate basic data for providing individually optimized instruction. Furthermore, the analysis unit can continuously monitor the user's physique data and update the profile as necessary. This enables the analysis unit to always provide optimal instruction based on the latest data.

The generation unit generates an optimal playing form and fingering method based on the data analyzed by the analysis unit. The generation unit can, for example, analyze a user's performance video and generate an ideal playing form and fingering method. Specifically, generative AI is used to analyze the user's performance video and generate an optimal playing form and fingering method. The generative AI utilizes video analysis technology based on deep learning to analyze the user's performance movements in detail. For example, the hand movements, finger positions, and body posture when the user plays an instrument are analyzed to identify the ideal playing form and fingering method. The generation unit can generate an optimal playing form and fingering method suited to the user's physique and playing style based on these data. Furthermore, the generation unit generates feedback for providing the generated playing form and fingering method to the user. This includes specific performance guidance and suggestions for practice methods. For example, feedback can be generated to suggest practice methods for improving specific performance techniques or to indicate specific points for improvement in playing form. Thus, the generation unit can generate an optimal playing form and fingering method suited to the user's physique and playing style and provide individually optimized instruction.

The provision unit provides feedback generated by the generation unit. The provision unit can, for example, display feedback generated by generative AI superimposed in AR on the user's performance. Specifically, AR technology is used to superimpose feedback in real time on the user's performance video. This allows the user to intuitively understand which parts to improve while watching their own performance. For example, when the user is playing an instrument, feedback can be displayed in real time on hand positions and finger movements, indicating the correct playing form and fingering method. The provision unit can use visual guides or animations to make it easier for the user to intuitively understand the feedback. This makes it easier for the user to grasp specific points for improvement while watching their own performance. In addition, the provision unit can record the user's response to feedback and reflect it in the next feedback. This enables the provision unit to provide appropriate feedback according to the user's progress and realize individually optimized instruction. Furthermore, the provision unit can flexibly adjust the feedback display method according to the environment or device when the user receives feedback. For example, feedback display can be provided for various devices such as smartphones, tablets, and AR glasses. Thus, the provision unit enables the user to receive optimal feedback in any environment.

The evaluation unit evaluates user progress based on the feedback provided by the provision unit and proposes new practice methods or tasks. Specifically, the evaluation unit analyzes the user's performance data and feedback history to evaluate the user's skill level and progress in detail. This includes a process of analyzing the user's performance data using machine learning algorithms to evaluate skill improvement and task achievement. For example, it is possible to evaluate how much time the user spent to master a specific performance technique and how accurately the user can now perform it. The evaluation unit uses these data to propose new practice methods or tasks according to the user's skill level. For example, it can specifically indicate practice methods for improving specific performance techniques or tasks to be mastered next. Furthermore, the evaluation unit periodically evaluates user progress and provides feedback to support continuous skill improvement. Thus, the evaluation unit can provide appropriate practice methods or tasks according to the user's skill level and realize individually optimized instruction. In addition, the evaluation unit can record the user's response to feedback and reflect it in the next evaluation to perform more accurate evaluation. This enables the evaluation unit to evaluate user progress in detail and generate basic data for providing individually optimized instruction.

The provision unit can display feedback generated by generative AI superimposed in AR on the user's performance. The provision unit can, for example, have the generative AI analyze the user's performance video, generate an ideal playing form and fingering method, and display the feedback in AR. The provision unit uses AR technology to display feedback so that the user can intuitively understand the feedback. For example, the provision unit can visually display the ideal playing form and fingering method superimposed on the user's performance video. This allows the user to practice while comparing their own performance with the ideal playing form. Some or all of the above-described processing in the provision unit may be performed using generative AI or may be performed without using generative AI. For example, the provision unit can use a system that takes feedback generated by generative AI as input and outputs AR display to display the feedback. This makes it easier for the user to intuitively understand the feedback.

The evaluation unit can periodically evaluate user progress and propose new practice methods or tasks according to the skill level. The evaluation unit can, for example, periodically analyze the user's performance video and evaluate progress. The evaluation unit proposes appropriate practice methods or tasks according to the user's skill level. For example, the evaluation unit can propose basic practice methods for beginners. The evaluation unit can also propose advanced practice methods or tasks for intermediate players. The evaluation unit evaluates user progress in detail and provides appropriate feedback according to the skill level. This allows the user to receive practice methods or tasks according to their skill level and efficiently improve their skills. Some or all of the above-described processing in the evaluation unit may be performed using AI or may be performed without using AI. For example, the evaluation unit can input the user's performance video to AI and have the AI perform progress evaluation. This enables the provision of appropriate practice methods or tasks according to the user's skill level.

The acquisition unit can acquire the user's physique data using a smartphone camera. The acquisition unit can, for example, have the user photograph their own physique with a smartphone camera and acquire the data. The acquisition unit automatically analyzes physique features such as the user's height, limb length, and joint positions using the smartphone camera. The acquisition unit provides a simple method using a smartphone camera so that the user can easily acquire physique data. For example, the acquisition unit can analyze image data photographed by the smartphone camera and extract physique data. This allows the user to easily acquire physique data without the need for special equipment. Some or all of the above-described processing in the acquisition unit may be performed using AI or may be performed without using AI. For example, the acquisition unit can input image data photographed by the smartphone camera to AI and have the AI perform physique data analysis. This allows the user to easily acquire physique data.

The analysis unit can generate a user-specific profile based on the acquired physique data. The analysis unit can, for example, analyze the acquired physique data in detail and generate a user-specific profile. The analysis unit generates basic data for providing individually optimized instruction based on the user's physique data. For example, the analysis unit analyzes physique features such as the user's height, limb length, and joint positions and generates a user-specific profile. This allows the user to receive an optimal playing form and fingering method suited to their own physique. Some or all of the above-described processing in the analysis unit may be performed using AI or may be performed without using AI. For example, the analysis unit can input the acquired physique data to AI and have the AI generate the user-specific profile. This enables the generation of a user-specific profile and individually optimized instruction.

The generation unit can analyze a user's performance video and generate an ideal playing form and fingering method. The generation unit can, for example, input the user's performance video to generative AI and have the generative AI generate the ideal playing form and fingering method. The generation unit uses generative AI to analyze the user's performance video and generate an optimal playing form and fingering method. For example, the generation unit can analyze the user's performance video in detail and generate an ideal playing form and fingering method. This allows the user to practice while comparing their own performance with the ideal playing form. Some or all of the above-described processing in the generation unit may be performed using generative AI or may be performed without using generative AI. For example, the generation unit can input the user's performance video to generative AI and have the generative AI generate the ideal playing form and fingering method. This enables the provision of ideal playing forms and fingering methods by analyzing the user's performance video.

The acquisition unit can estimate the user's emotion and adjust the timing of acquiring physique data based on the estimated emotion. The acquisition unit can, for example, prompt the user to take a photo in a relaxed state to acquire physique data in a natural posture if the user is relaxed. If the user is nervous, the acquisition unit can provide guidance to help the user relax and acquire physique data in a relaxed state. If the user is in a hurry, the acquisition unit can provide simplified procedures to quickly acquire physique data. This allows physique data to be acquired at the optimal timing according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the acquisition unit may be performed using AI or may be performed without using AI. For example, the acquisition unit can input the user's facial expression data to the generative AI and have the generative AI perform emotion estimation. This allows physique data to be acquired at the optimal timing according to the user's emotion.

The acquisition unit can analyze the user's past physique data and select an optimal acquisition method. The acquisition unit can, for example, select the method that obtained the most accurate data based on the user's past physique data. The acquisition unit can also analyze fluctuations in the user's past physique data and select a stable data acquisition method. The acquisition unit can also consider the frequency of acquisition of the user's past physique data and select the optimal acquisition timing. This allows physique data to be acquired by the optimal method based on past data. Some or all of the above-described processing in the acquisition unit may be performed using AI or may be performed without using AI. For example, the acquisition unit can input the user's past physique data to AI and have the AI select the optimal acquisition method. This allows physique data to be acquired by the optimal method based on past data.

The acquisition unit can perform filtering based on the user's current health condition and lifestyle habits when acquiring physique data. The acquisition unit can, for example, consider the user's current health condition and acquire physique data when the user is in good condition. The acquisition unit can also analyze the user's lifestyle habits and acquire physique data at the most suitable time of day. The acquisition unit can also select the type of data to be acquired based on the user's health condition and lifestyle habits. This allows data to be acquired according to the user's health condition and lifestyle habits. Some or all of the above-described processing in the acquisition unit may be performed using AI or may be performed without using AI. For example, the acquisition unit can input the user's health data to AI and have the AI perform filtering. This allows data to be acquired according to the user's health condition and lifestyle habits.

The acquisition unit can estimate the user's emotion and determine the priority of physique data to be acquired based on the estimated emotion. The acquisition unit can, for example, preferentially acquire detailed physique data if the user is relaxed. If the user is nervous, the acquisition unit can preferentially acquire basic physique data. If the user is in a hurry, the acquisition unit can preferentially acquire the most important physique data. This allows important data to be preferentially acquired according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the acquisition unit may be performed using AI or may be performed without using AI. For example, the acquisition unit can input the user's facial expression data to the generative AI and have the generative AI perform emotion estimation. This allows important data to be preferentially acquired according to the user's emotion.

The acquisition unit can consider the user's geographic location information when acquiring physique data and preferentially acquire highly relevant data. The acquisition unit can, for example, preferentially acquire data related to oxygen concentration and atmospheric pressure when the user is at high altitude. The acquisition unit can also preferentially acquire data related to environmental noise and vibration when the user is in an urban area. The acquisition unit can also preferentially acquire data related to indoor temperature and humidity when the user is indoors. This allows highly relevant data to be acquired based on the user's geographic location information. Some or all of the above-described processing in the acquisition unit may be performed using AI or may be performed without using AI. For example, the acquisition unit can input the user's geographic location data to AI and have the AI acquire highly relevant data. This allows highly relevant data to be acquired based on the user's geographic location information.

The acquisition unit can analyze the user's social media activity when acquiring physique data and acquire relevant data. The acquisition unit can, for example, acquire physique data related to the activity if the user posts about exercise on social media. The acquisition unit can also acquire physique data based on information shared by the user about health on social media. The acquisition unit can also acquire physique data related to specific events if the user participates in such events on social media. This allows relevant data to be acquired based on the user's social media activity. Some or all of the above-described processing in the acquisition unit may be performed using AI or may be performed without using AI. For example, the acquisition unit can input the user's social media data to AI and have the AI acquire relevant data. This allows relevant data to be acquired based on the user's social media activity.

The analysis unit can estimate the user's emotion and adjust the expression method of analysis based on the estimated emotion. The analysis unit can, for example, provide detailed analysis results if the user is relaxed. If the user is nervous, the analysis unit can provide concise and focused analysis results. If the user is in a hurry, the analysis unit can provide visual analysis results for quick understanding. This allows the expression method of analysis results to be adjusted according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the analysis unit may be performed using AI or may be performed without using AI. For example, the analysis unit can input the user's facial expression data to the generative AI and have the generative AI perform emotion estimation. This allows the expression method of analysis results to be adjusted according to the user's emotion.

The analysis unit can adjust the level of detail of analysis based on the importance of the physique data during analysis. The analysis unit can, for example, perform detailed analysis for important physique data. The analysis unit can also perform simplified analysis for basic physique data. The analysis unit can also perform detailed analysis according to the purpose for physique data related to a specific purpose. This allows detailed analysis to be performed for important data. Some or all of the above-described processing in the analysis unit may be performed using AI or may be performed without using AI. For example, the analysis unit can input physique data to AI and have the AI adjust the level of detail of analysis based on importance. This allows detailed analysis to be performed for important data.

The analysis unit can apply different analysis algorithms according to the category of the physique data during analysis. The analysis unit can, for example, apply a skeletal analysis algorithm to skeletal data. The analysis unit can also apply a muscle analysis algorithm to muscle data. The analysis unit can also apply a joint analysis algorithm to joint data. This allows appropriate analysis to be performed according to the category of data. Some or all of the above-described processing in the analysis unit may be performed using AI or may be performed without using AI. For example, the analysis unit can input physique data to AI and have the AI apply analysis algorithms according to the category. This allows appropriate analysis to be performed according to the category of data.

The analysis unit can estimate the user's emotion and adjust the length of analysis based on the estimated emotion. The analysis unit can, for example, perform detailed analysis and provide a longer report if the user is relaxed. If the user is nervous, the analysis unit can perform concise analysis and provide a shorter report. If the user is in a hurry, the analysis unit can perform a short analysis focusing on key points. This allows the length of analysis to be adjusted according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the analysis unit may be performed using AI or may be performed without using AI. For example, the analysis unit can input the user's facial expression data to the generative AI and have the generative AI perform emotion estimation. This allows the length of analysis to be adjusted according to the user's emotion.

The analysis unit can determine the priority of analysis based on the acquisition timing of the physique data during analysis. The analysis unit can, for example, preferentially analyze the latest physique data. The analysis unit can also analyze the latest data while referring to past physique data. The analysis unit can also preferentially analyze physique data acquired during a specific period. This allows the latest data to be preferentially analyzed. Some or all of the above-described processing in the analysis unit may be performed using AI or may be performed without using AI. For example, the analysis unit can input physique data to AI and have the AI determine the priority of analysis based on acquisition timing. This allows the latest data to be preferentially analyzed.

The analysis unit can adjust the order of analysis based on the relevance of the physique data during analysis. The analysis unit can, for example, preferentially analyze important physique data. The analysis unit can also preferentially analyze highly relevant physique data. The analysis unit can also preferentially analyze physique data related to a specific purpose. This allows highly relevant data to be preferentially analyzed. Some or all of the above-described processing in the analysis unit may be performed using AI or may be performed without using AI. For example, the analysis unit can input physique data to AI and have the AI adjust the order of analysis based on relevance. This allows highly relevant data to be preferentially analyzed.

The generation unit can estimate the user's emotion and adjust the method of expressing the generated performance form and fingering technique based on the estimated user's emotion. For example, when the user is relaxed, the generation unit provides detailed performance forms and fingering techniques. When the user is nervous, the generation unit can also provide concise and essential performance forms and fingering techniques. When the user is in a hurry, the generation unit can also provide visually understandable performance forms and fingering techniques for quick comprehension. In this way, the method of expressing performance forms and fingering techniques can be adjusted according to the user's emotion. Emotion estimation is realized, for example, by using an emotion estimation function employing an emotion engine or a generative AI. The generative AI may be a text generation AI (for example, an LLM) or a multimodal generative AI, but is not limited to these examples. Some or all of the above-described processing in the generation unit may be performed using AI, or may be performed without using AI. For example, the generation unit can input the user's facial expression data to the generative AI and have the generative AI perform emotion estimation. Thus, the method of expressing performance forms and fingering techniques can be adjusted according to the user's emotion.

The generation unit can adjust the level of detail of generation based on the importance of the physique data during generation. The generation unit can, for example, generate detailed playing forms and fingering methods based on important physique data. The generation unit can also generate simplified playing forms and fingering methods based on basic physique data. The generation unit can also generate detailed playing forms and fingering methods according to the purpose based on physique data related to a specific purpose. This allows detailed playing forms and fingering methods to be generated based on important data. Some or all of the above-described processing in the generation unit may be performed using AI or may be performed without using AI. For example, the generation unit can input physique data to AI and have the AI adjust the level of detail of generation based on importance. This allows detailed playing forms and fingering methods to be generated based on important data.

The generation unit can apply different generation algorithms according to the category of the physique data during generation. The generation unit can, for example, generate playing forms and fingering methods suitable for the skeleton based on skeletal data. The generation unit can also generate playing forms and fingering methods suitable for muscles based on muscle data. The generation unit can also generate playing forms and fingering methods suitable for joints based on joint data. This allows appropriate playing forms and fingering methods to be generated according to the category of data. Some or all of the above-described processing in the generation unit may be performed using AI or may be performed without using AI. For example, the generation unit can input physique data to AI and have the AI apply generation algorithms according to the category. This allows appropriate playing forms and fingering methods to be generated according to the category of data.

The generation unit can estimate the user's emotion and adjust the length of the generated playing form or fingering method based on the estimated emotion. The generation unit can, for example, provide detailed playing forms and fingering methods if the user is relaxed. If the user is nervous, the generation unit can provide concise and focused playing forms and fingering methods. If the user is in a hurry, the generation unit can provide visual playing forms and fingering methods for quick understanding. This allows the length of playing forms and fingering methods to be adjusted according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the generation unit may be performed using AI or may be performed without using AI. For example, the generation unit can input the user's facial expression data to the generative AI and have the generative AI perform emotion estimation. This allows the length of playing forms and fingering methods to be adjusted according to the user's emotion.

The generation unit can determine the priority of generation based on the acquisition timing of the physique data during generation. The generation unit can, for example, generate playing forms and fingering methods based on the latest physique data. The generation unit can also generate playing forms and fingering methods based on the latest data while referring to past physique data. The generation unit can also generate playing forms and fingering methods based on physique data acquired during a specific period. This allows playing forms and fingering methods to be generated based on the latest data. Some or all of the above-described processing in the generation unit may be performed using AI or may be performed without using AI. For example, the generation unit can input physique data to AI and have the AI determine the priority of generation based on acquisition timing. This allows playing forms and fingering methods to be generated based on the latest data.

The generation unit can adjust the order of generation based on the relevance of the physique data during generation. The generation unit can, for example, preferentially generate playing forms and fingering methods based on important physique data. The generation unit can also preferentially generate playing forms and fingering methods based on highly relevant physique data. The generation unit can also preferentially generate playing forms and fingering methods based on physique data related to a specific purpose. This allows playing forms and fingering methods to be preferentially generated based on highly relevant data. Some or all of the above-described processing in the generation unit may be performed using AI or may be performed without using AI. For example, the generation unit can input physique data to AI and have the AI adjust the order of generation based on relevance. This allows playing forms and fingering methods to be preferentially generated based on highly relevant data.

The provision unit can estimate the user's emotion and adjust the display method of feedback based on the estimated emotion. The provision unit can, for example, provide detailed feedback if the user is relaxed. If the user is nervous, the provision unit can provide concise and focused feedback. If the user is in a hurry, the provision unit can provide visual feedback for quick understanding. This allows the display method of feedback to be adjusted according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the provision unit may be performed using AI or may be performed without using AI. For example, the provision unit can input the user's facial expression data to the generative AI and have the generative AI perform emotion estimation. This allows the display method of feedback to be adjusted according to the user's emotion.

The provision unit can refer to the user's past feedback history when providing feedback and select an optimal display method. The provision unit can, for example, select the most effective display method based on the user's past feedback history. The provision unit can also analyze the user's past feedback history and select an easy-to-understand display method. The provision unit can also adjust the display order of feedback with reference to the user's past feedback history. This allows the optimal display method to be selected based on past feedback history. Some or all of the above-described processing in the provision unit may be performed using AI or may be performed without using AI. For example, the provision unit can input the user's feedback history to AI and have the AI select the optimal display method. This allows the optimal display method to be selected based on past feedback history.

The provision unit can customize the content of feedback based on the user's current performance status when providing feedback. The provision unit can, for example, analyze the user's current performance status and provide appropriate feedback. The provision unit can also adjust the level of detail of feedback according to the user's performance status. The provision unit can also determine the priority of feedback based on the user's performance status. This allows appropriate feedback to be provided according to the current performance status. Some or all of the above-described processing in the provision unit may be performed using AI or may be performed without using AI. For example, the provision unit can input the user's performance data to AI and have the AI customize the feedback. This allows appropriate feedback to be provided according to the current performance status.

The provision unit can estimate the user's emotion and determine the priority of feedback based on the estimated emotion. The provision unit can, for example, preferentially provide detailed feedback if the user is relaxed. If the user is nervous, the provision unit can preferentially provide concise and focused feedback. If the user is in a hurry, the provision unit can preferentially provide visual feedback for quick understanding. This allows important feedback to be preferentially provided according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the provision unit may be performed using AI or may be performed without using AI. For example, the provision unit can input the user's facial expression data to the generative AI and have the generative AI perform emotion estimation. This allows important feedback to be preferentially provided according to the user's emotion.

The provision unit can consider the user's geographic location information when providing feedback and select an optimal feedback method. The provision unit can, for example, preferentially provide visual feedback when the user is outdoors. The provision unit can also provide detailed feedback when the user is indoors. The provision unit can also provide concise and focused feedback when the user is on the move. This allows the optimal feedback method to be selected based on geographic location information. Some or all of the above-described processing in the provision unit may be performed using AI or may be performed without using AI. For example, the provision unit can input the user's geographic location data to AI and have the AI select the optimal feedback method. This allows the optimal feedback method to be selected based on geographic location information.

The provision unit can analyze the user's social media activity when providing feedback and propose feedback means. The provision unit can, for example, provide feedback related to the activity if the user posts about exercise on social media. The provision unit can also provide feedback based on information shared by the user about health on social media. The provision unit can also provide feedback related to specific events if the user participates in such events on social media. This allows appropriate feedback means to be proposed based on social media activity. Some or all of the above-described processing in the provision unit may be performed using AI or may be performed without using AI. For example, the provision unit can input the user's social media data to AI and have the AI propose feedback means. This allows appropriate feedback means to be proposed based on social media activity.

The evaluation unit can estimate the user's emotion and adjust the evaluation method based on the estimated emotion. The evaluation unit can, for example, provide detailed evaluation if the user is relaxed. If the user is nervous, the evaluation unit can provide concise and focused evaluation. If the user is in a hurry, the evaluation unit can provide visual evaluation for quick understanding. This allows the evaluation method to be adjusted according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the evaluation unit may be performed using AI or may be performed without using AI. For example, the evaluation unit can input the user's facial expression data to the generative AI and have the generative AI perform emotion estimation. This allows the evaluation method to be adjusted according to the user's emotion.

The evaluation unit can analyze the user's past performance data during evaluation and select an optimal evaluation method. The evaluation unit can, for example, select the most effective evaluation method based on the user's past performance data. The evaluation unit can also analyze the user's past performance data and select an easy-to-understand evaluation method. The evaluation unit can also adjust the display order of evaluation with reference to the user's past performance data. This allows the optimal evaluation method to be selected based on past performance data. Some or all of the above-described processing in the evaluation unit may be performed using AI or may be performed without using AI. For example, the evaluation unit can input the user's performance data to AI and have the AI select the optimal evaluation method. This allows the optimal evaluation method to be selected based on past performance data.

The evaluation unit can customize evaluation criteria based on the user's current skill level during evaluation. The evaluation unit can, for example, analyze the user's current skill level and set appropriate evaluation criteria. The evaluation unit can also adjust the level of detail of evaluation according to the user's skill level. The evaluation unit can also determine the priority of evaluation based on the user's skill level. This allows appropriate evaluation criteria to be set according to the current skill level. Some or all of the above-described processing in the evaluation unit may be performed using AI or may be performed without using AI. For example, the evaluation unit can input the user's skill data to AI and have the AI customize the evaluation criteria. This allows appropriate evaluation criteria to be set according to the current skill level.

The evaluation unit can estimate the user's emotion and determine the priority of evaluation based on the estimated emotion. The evaluation unit can, for example, preferentially provide detailed evaluation if the user is relaxed. If the user is nervous, the evaluation unit can preferentially provide concise and focused evaluation. If the user is in a hurry, the evaluation unit can preferentially provide visual evaluation for quick understanding. This allows important evaluation to be preferentially provided according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the evaluation unit may be performed using AI or may be performed without using AI. For example, the evaluation unit can input the user's facial expression data to the generative AI and have the generative AI perform emotion estimation. This allows important evaluation to be preferentially provided according to the user's emotion.

The evaluation unit can consider the user's geographic location information during evaluation and select an optimal evaluation method. The evaluation unit can, for example, preferentially provide visual evaluation when the user is outdoors. The evaluation unit can also provide detailed evaluation when the user is indoors. The evaluation unit can also provide concise and focused evaluation when the user is on the move. This allows the optimal evaluation method to be selected based on geographic location information. Some or all of the above-described processing in the evaluation unit may be performed using AI or may be performed without using AI. For example, the evaluation unit can input the user's geographic location data to AI and have the AI select the optimal evaluation method. This allows the optimal evaluation method to be selected based on geographic location information.

The evaluation unit can analyze the user's social media activity during evaluation and propose evaluation means. The evaluation unit can, for example, provide evaluation related to the activity if the user posts about exercise on social media. The evaluation unit can also provide evaluation based on information shared by the user about health on social media. The evaluation unit can also provide evaluation related to specific events if the user participates in such events on social media. This allows appropriate evaluation means to be proposed based on social media activity. Some or all of the above-described processing in the evaluation unit may be performed using AI or may be performed without using AI. For example, the evaluation unit can input the user's social media data to AI and have the AI propose evaluation means. This allows appropriate evaluation means to be proposed based on social media activity.

The system according to the embodiment is not limited to the above examples and can be variously modified, for example, as follows.

The acquisition unit can acquire, in addition to the user's physique data, the user's lifestyle data. For example, data such as the user's sleep patterns, dietary content, and exercise habits are acquired, and the user's physical condition and energy level are estimated based on these data. The analysis unit can generate an optimal practice schedule considering the user's physical condition and energy level based on the acquired lifestyle data. The generation unit generates practice content according to the user's physical condition and energy level based on the analysis results. The provision unit provides the generated practice content to the user and supports the user to continue practicing without difficulty. This enables individually optimized instruction according to the user's lifestyle.

The provision unit can estimate the user's emotion and adjust the content of feedback based on the estimated emotion. For example, the provision unit can provide detailed feedback if the user is relaxed. If the user is nervous, the provision unit can provide concise and focused feedback. If the user is in a hurry, the provision unit can provide visual feedback for quick understanding. This allows appropriate feedback to be provided according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the provision unit may be performed using AI or may be performed without using AI. For example, the provision unit can input the user's facial expression data to the generative AI and have the generative AI perform emotion estimation. This allows appropriate feedback to be provided according to the user's emotion.

The evaluation unit can analyze the user's past practice data and select an optimal evaluation method. For example, the evaluation unit selects the most effective evaluation method based on the user's past practice data. The evaluation unit can also analyze the user's past practice data and select an easy-to-understand evaluation method. The evaluation unit can also adjust the display order of evaluation with reference to the user's past practice data. This allows the optimal evaluation method to be selected based on past practice data. Some or all of the above-described processing in the evaluation unit may be performed using AI or may be performed without using AI. For example, the evaluation unit can input the user's practice data to AI and have the AI select the optimal evaluation method. This allows the optimal evaluation method to be selected based on past practice data.

The acquisition unit can acquire, in addition to the user's physique data, the user's health data. For example, data such as the user's heart rate, blood pressure, and body temperature are acquired, and the user's health condition is estimated based on these data. The analysis unit can generate an optimal practice schedule considering the user's health condition based on the acquired health data. The generation unit generates practice content according to the user's health condition based on the analysis results. The provision unit provides the generated practice content to the user and supports the user to continue practicing without difficulty. This enables individually optimized instruction according to the user's health condition.

The analysis unit can estimate the user's emotion and adjust the expression method of analysis based on the estimated emotion. For example, the analysis unit can provide detailed analysis results if the user is relaxed. If the user is nervous, the analysis unit can provide concise and focused analysis results. If the user is in a hurry, the analysis unit can provide visual analysis results for quick understanding. This allows the expression method of analysis results to be adjusted according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the analysis unit may be performed using AI or may be performed without using AI.

For example, the analysis unit can input the user's facial expression data to the generative AI and have the generative AI perform emotion estimation. This allows the expression method of analysis results to be adjusted according to the user's emotion.

The generation unit can analyze, in addition to the user's performance video, the user's audio data and generate an optimal playing form and fingering method. For example, the user's audio data during performance is acquired, and the strength of sound and accuracy of rhythm are analyzed. The generation unit can adjust the user's playing form and fingering method based on the analysis results of the audio data. The provision unit provides the generated playing form and fingering method to the user and supports the user in improving musical expressiveness. This enables individually optimized instruction utilizing audio data.

The acquisition unit can estimate the user's emotion and adjust the timing of acquiring physique data based on the estimated emotion. For example, the acquisition unit can prompt the user to take a photo in a relaxed state to acquire physique data in a natural posture if the user is relaxed. If the user is nervous, the acquisition unit can provide guidance to help the user relax and acquire physique data in a relaxed state. If the user is in a hurry, the acquisition unit can provide simplified procedures to quickly acquire physique data. This allows physique data to be acquired at the optimal timing according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the acquisition unit may be performed using AI or may be performed without using AI. For example, the acquisition unit can input the user's facial expression data to the generative AI and have the generative AI perform emotion estimation. This allows physique data to be acquired at the optimal timing according to the user's emotion.

The evaluation unit can perform evaluation considering, in addition to the user's performance data, the user's musical preferences and goals. For example, the user's preferred music genre and target performance style are acquired, and evaluation criteria are set based on this information. The evaluation unit can adjust the level of detail of evaluation and the content of feedback according to the user's musical preferences and goals. This allows appropriate evaluation to be provided according to the user's individual goals. Some or all of the above-described processing in the evaluation unit may be performed using AI or may be performed without using AI. For example, the evaluation unit can input the user's musical preferences and goal data to AI and have the AI set the evaluation criteria. This allows appropriate evaluation to be provided according to the user's musical preferences and goals.

The provision unit can estimate the user's emotion and adjust the display method of feedback based on the estimated emotion. For example, the provision unit can provide detailed feedback if the user is relaxed. If the user is nervous, the provision unit can provide concise and focused feedback. If the user is in a hurry, the provision unit can provide visual feedback for quick understanding. This allows the display method of feedback to be adjusted according to the user's emotion. Emotion estimation is realized, for example, by using an emotion engine or a generative AI as an emotion estimation function. The generative AI may be a text generative AI (e.g., LLM) or a multimodal generative AI, but is not limited to such examples. Some or all of the above-described processing in the provision unit may be performed using AI or may be performed without using AI. For example, the provision unit can input the user's facial expression data to the generative AI and have the generative AI perform emotion estimation. This allows the display method of feedback to be adjusted according to the user's emotion.

The acquisition unit can acquire, in addition to the user's physique data, the user's geographic location information. For example, when the user is at high altitude, data related to oxygen concentration and atmospheric pressure are acquired. When the user is in an urban area, data related to environmental noise and vibration can also be acquired. When the user is indoors, data related to indoor temperature and humidity can also be acquired. This allows highly relevant data to be acquired based on the user's geographic location information. Some or all of the above-described processing in the acquisition unit may be performed using AI or may be performed without using AI. For example, the acquisition unit can input the user's geographic location data to AI and have the AI acquire highly relevant data. This allows highly relevant data to be acquired based on the user's geographic location information.

The flow of processing in Example 2 of the Embodiment will be briefly described below.
Step 1: The acquisition unit acquires the user's physique data. The acquisition unit can, for example, acquire the user's physique data using a smartphone camera. The acquisition unit automatically analyzes physique features such as the user's height, limb length, and joint positions.
Step 2: The analysis unit analyzes the physique data acquired by the acquisition unit. The analysis unit can, for example, generate a user-specific profile based on the acquired physique data. The analysis unit analyzes the user's physique data in detail and generates basic data for providing individually optimized instruction.
Step 3: The generation unit generates an optimal playing form and fingering method based on the data analyzed by the analysis unit. The generation unit can, for example, analyze a user's performance video and generate an ideal playing form and fingering method. The generation unit uses generative AI to analyze the user's performance video and generate an optimal playing form and fingering method.
Step 4: The provision unit provides feedback generated by the generation unit. The provision unit can, for example, display feedback generated by generative AI superimposed in AR on the user's performance. The provision unit uses AR technology to display feedback so that the user can intuitively understand the feedback.
Step 5: The evaluation unit evaluates user progress based on the feedback provided by the provision unit and proposes new practice methods or tasks. The evaluation unit can, for example, periodically evaluate user progress and propose new practice methods or tasks according to the skill level. The evaluation unit evaluates progress in detail to provide appropriate practice methods or tasks according to the user's skill level.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described acquisition unit, analysis unit, generation unit, provision unit, and evaluation unit is implemented by at least one of, for example, the smart device 14 and the data processing apparatus 12. For example, the acquisition unit acquires the user's physique data using the camera 42 of the smart device 14. The analysis unit analyzes the physique data acquired by the specific processing unit 290 of the data processing apparatus 12 and generates a user-specific profile. The generation unit generates an optimal playing form and fingering method based on the data analyzed by the specific processing unit 290 of the data processing apparatus 12. The provision unit displays feedback generated by the control unit 46A of the smart device 14 superimposed in AR on the user's performance. The evaluation unit evaluates the user's progress by the specific processing unit 290 of the data processing apparatus 12 and proposes new practice methods or tasks. The correspondence between each unit and the device or control unit is not limited to the above examples and various modifications are possible.

### Second Embodiment

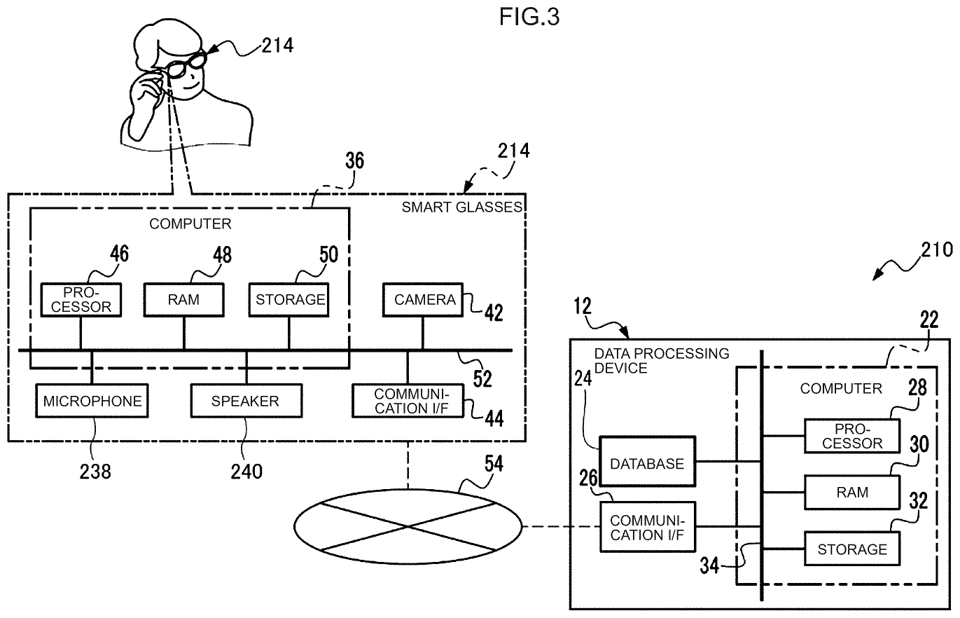

FIG. 3 shows an example configuration of a data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 includes a computer 36, a microphone 238, a speaker 240, a camera 42, and a communication I/F 44. The computer 36 includes a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

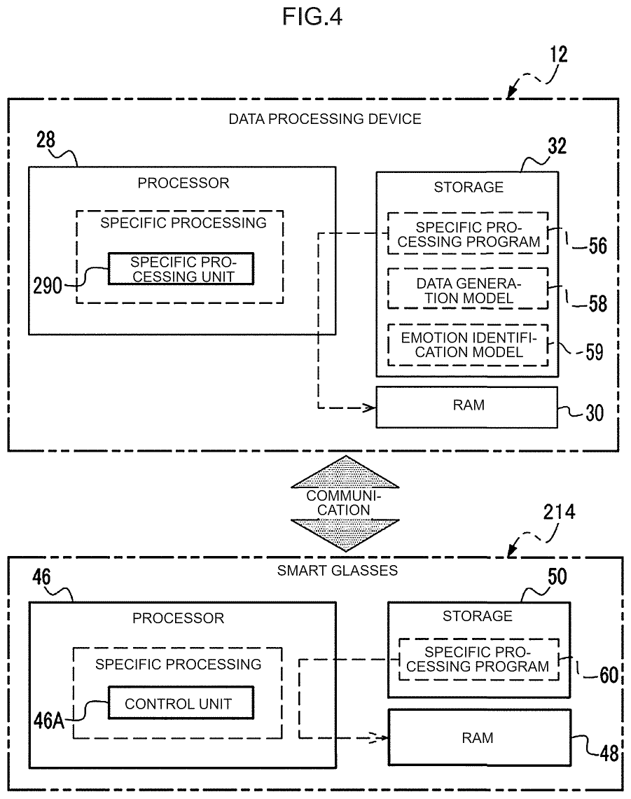

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described acquisition unit, analysis unit, generation unit, provision unit, and evaluation unit is implemented by at least one of, for example, the smart glasses 214 and the data processing apparatus 12. For example, the acquisition unit acquires the user's physique data using the camera 42 of the smart glasses 214. The analysis unit analyzes the physique data acquired by the specific processing unit 290 of the data processing apparatus 12 and generates a user-specific profile. The generation unit generates an optimal playing form and fingering method based on the data analyzed by the specific processing unit 290 of the data processing apparatus 12. The provision unit displays feedback generated by the control unit 46A of the smart glasses 214 superimposed in AR on the user's performance. The evaluation unit evaluates the user's progress by the specific processing unit 290 of the data processing apparatus 12 and proposes new practice methods or tasks. The correspondence between each unit and the device or control unit is not limited to the above examples and various modifications are possible.

### Third Embodiment

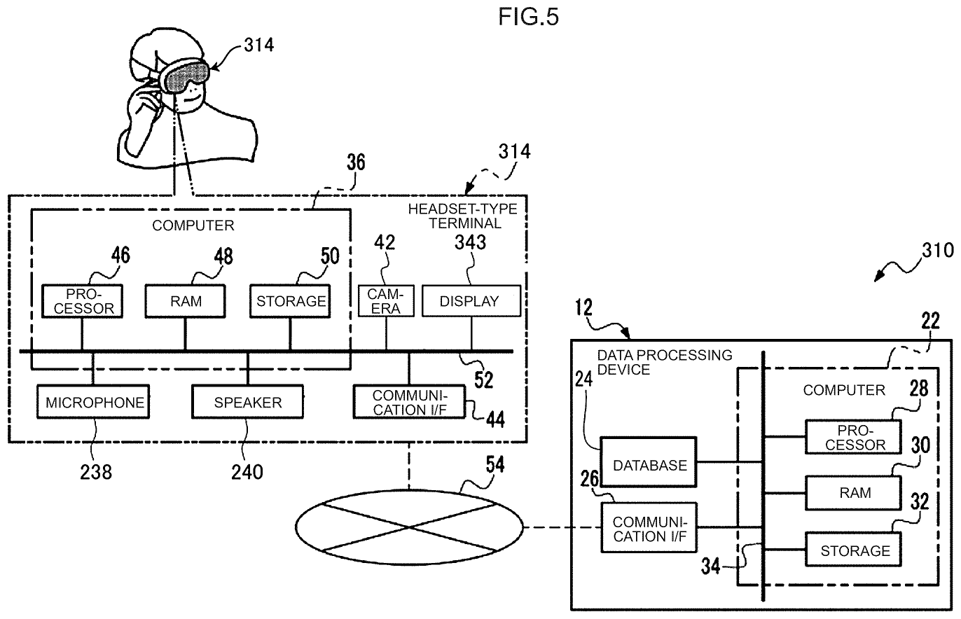

FIG. 5 shows an example configuration of a data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 includes a computer 36, a microphone 238, a speaker 240, a camera 42, a communication I/F 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

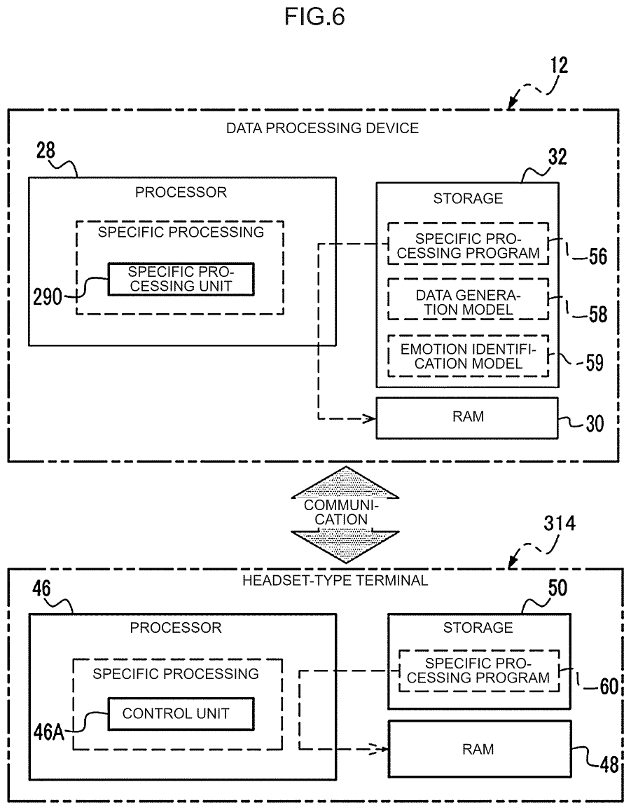

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described acquisition unit, analysis unit, generation unit, provision unit, and evaluation unit is implemented by at least one of, for example, the headset-type terminal 314 and the data processing apparatus 12. For example, the acquisition unit acquires the user's physique data using the camera 42 of the headset-type terminal 314. The analysis unit analyzes the physique data acquired by the specific processing unit 290 of the data processing apparatus 12 and generates a user-specific profile. The generation unit generates an optimal playing form and fingering method based on the data analyzed by the specific processing unit 290 of the data processing apparatus 12. The provision unit displays feedback generated by the control unit 46A of the headset-type terminal 314 superimposed in AR on the user's performance. The evaluation unit evaluates the user's progress by the specific processing unit 290 of the data processing apparatus 12 and proposes new practice methods or tasks. The correspondence between each unit and the device or control unit is not limited to the above examples and various modifications are possible.

### Fourth Embodiment

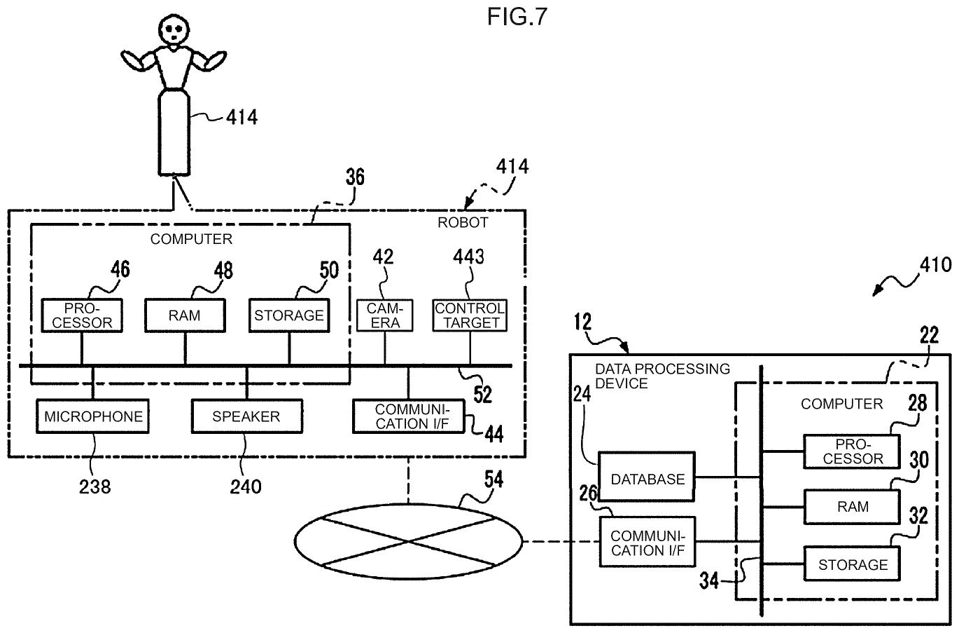

FIG. 7 shows an example configuration of a data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 includes a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 includes a computer 36, a microphone 238, a speaker 240, a camera 42, a communication I/F 44, and a control target 443. The computer 36 includes a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

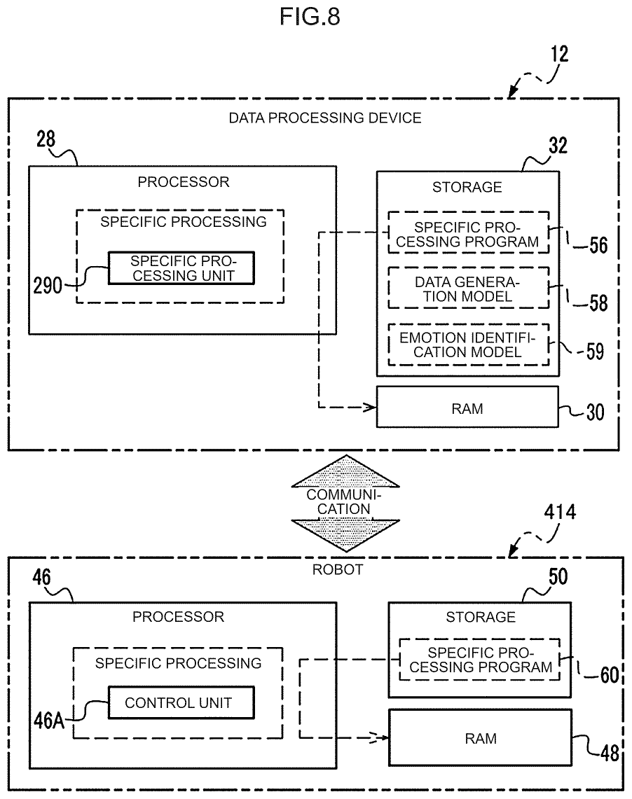

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described acquisition unit, analysis unit, generation unit, provision unit, and evaluation unit is implemented by at least one of, for example, the robot 414 and the data processing apparatus 12. For example, the acquisition unit acquires the user's physique data using the camera 42 of the robot 414. The analysis unit analyzes the physique data acquired by the specific processing unit 290 of the data processing apparatus 12 and generates a user-specific profile. The generation unit generates an optimal playing form and fingering method based on the data analyzed by the specific processing unit 290 of the data processing apparatus 12. The provision unit displays feedback generated by the control unit 46A of the robot 414 superimposed in AR on the user's performance. The evaluation unit evaluates the user's progress by the specific processing unit 290 of the data processing apparatus 12 and proposes new practice methods or tasks. The correspondence between each unit and the device or control unit is not limited to the above examples and various modifications are possible.

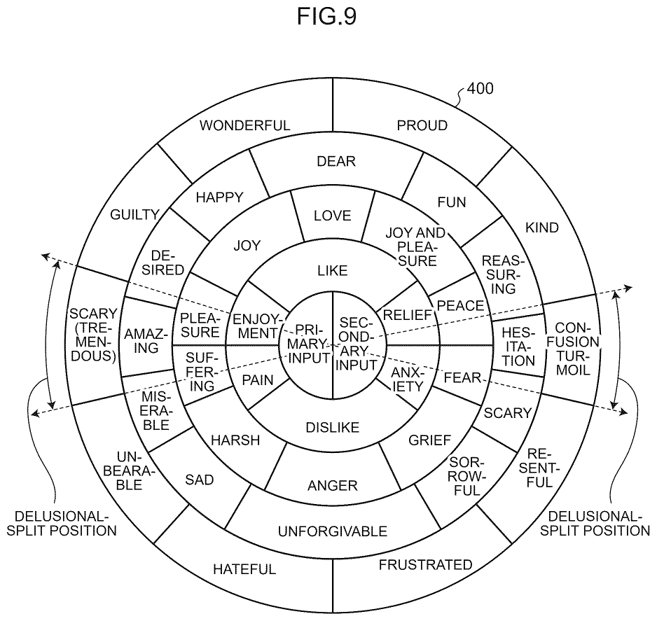

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr.

Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

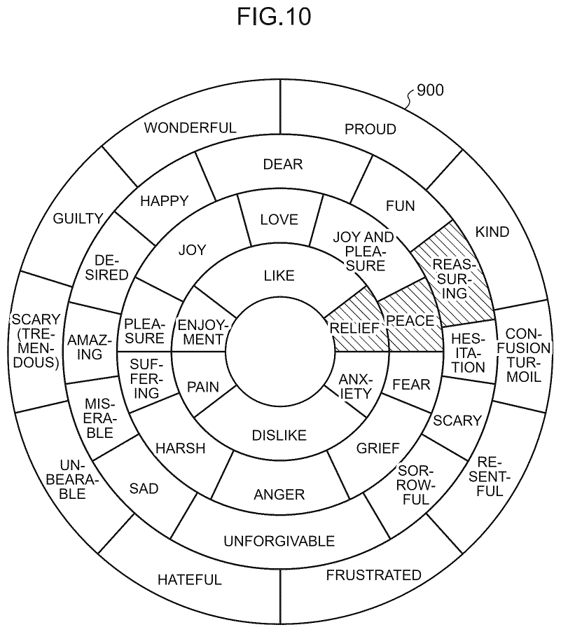

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used. Additionally, the examples described above were explained by dividing into form example 1 and form example 2, but these may be combined.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
[Additional Note 1] A system including: an acquisition unit configured to acquire physique data; an analysis unit configured to analyze the physique data acquired by the acquisition unit; a generation unit configured to generate an optimal playing form and fingering method based on the data analyzed by the analysis unit; a provision unit configured to provide feedback generated by the generation unit; and an evaluation unit configured to evaluate user progress based on the feedback provided by the provision unit and propose new practice methods or tasks.

[Additional Note 2] The system according to Additional Note 1, wherein the provision unit is configured to display feedback generated by a generative AI superimposed in AR on the user's performance.

[Additional Note 3] The system according to Additional Note 1, wherein the evaluation unit is configured to periodically evaluate user progress and propose new practice methods or tasks according to the skill level.

[Additional Note 4] The system according to Additional Note 1, wherein the acquisition unit is configured to acquire the user's physique data using a smartphone camera.

[Additional Note 5] The system according to Additional Note 1, wherein the analysis unit is configured to generate a user-specific profile based on the acquired physique data.
[Additional Note 6] The system according to Additional Note 1, wherein the generation unit is configured to analyze a user's performance video and generate an ideal playing form and fingering method.

[Additional Note 7] The system according to Additional Note 1, wherein the acquisition unit is configured to estimate the user's emotion and adjust the timing of acquiring physique data based on the estimated emotion.

[Additional Note 8] The system according to Additional Note 1, wherein the acquisition unit is configured to analyze the user's past physique data and select an optimal acquisition method.

[Additional Note 9] The system according to Additional Note 1, wherein the acquisition unit is configured to perform filtering based on the user's current health condition and lifestyle habits when acquiring physique data.
[Additional Note 10] The system according to Additional Note 1, wherein the acquisition unit is configured to estimate the user's emotion and determine the priority of physique data to be acquired based on the estimated emotion.
[Additional Note 11] The system according to Additional Note 1, wherein the acquisition unit is configured to consider the user's geographic location information when acquiring physique data and preferentially acquire highly relevant data.
[Additional Note 12] The system according to Additional Note 1, wherein the acquisition unit is configured to analyze the user's social media activity when acquiring physique data and acquire relevant data.
[Additional Note 13] The system according to Additional Note 1, wherein the analysis unit is configured to estimate the user's emotion and adjust the expression method of analysis based on the estimated emotion.
[Additional Note 14] The system according to Additional Note 1, wherein the analysis unit is configured to adjust the level of detail of analysis based on the importance of the physique data during analysis.
[Additional Note 15] The system according to Additional Note 1, wherein the analysis unit is configured to apply different analysis algorithms according to the category of the physique data during analysis.
[Additional Note 16] The system according to Additional Note 1, wherein the analysis unit is configured to estimate the user's emotion and adjust the length of analysis based on the estimated emotion.
[Additional Note 17] The system according to Additional Note 1, wherein the analysis unit is configured to determine the priority of analysis based on the acquisition timing of the physique data during analysis.
[Additional Note 18] The system according to Additional Note 1, wherein the analysis unit is configured to adjust the order of analysis based on the relevance of the physique data during analysis.
[Additional Note 19] The system according to Additional Note 1, wherein the generation unit is configured to estimate the user's emotion and adjust the expression method of the generated playing form or fingering method based on the estimated emotion.
[Additional Note 20] The system according to Additional Note 1, wherein the generation unit is configured to adjust the level of detail of generation based on the importance of the physique data during generation.
[Additional Note 21] The system according to Additional Note 1, wherein the generation unit is configured to apply different generation algorithms according to the category of the physique data during generation.
[Additional Note 22] The system according to Additional Note 1, wherein the generation unit is configured to estimate the user's emotion and adjust the length of the generated playing form or fingering method based on the estimated emotion.
[Additional Note 23] The system according to Additional Note 1, wherein the generation unit is configured to determine the priority of generation based on the acquisition timing of the physique data during generation.
[Additional Note 24] The system according to Additional Note 1, wherein the generation unit is configured to adjust the order of generation based on the relevance of the physique data during generation.
[Additional Note 25] The system according to Additional Note 1, wherein the provision unit is configured to estimate the user's emotion and adjust the display method of feedback based on the estimated emotion.
[Additional Note 26] The system according to Additional Note 1, wherein the provision unit is configured to refer to the user's past feedback history when providing feedback and select an optimal display method.
[Additional Note 27] The system according to Additional Note 1, wherein the provision unit is configured to customize the content of feedback based on the user's current performance status when providing feedback.
[Additional Note 28] The system according to Additional Note 1, wherein the provision unit is configured to estimate the user's emotion and determine the priority of feedback based on the estimated emotion.
[Additional Note 29] The system according to Additional Note 1, wherein the provision unit is configured to consider the user's geographic location information when providing feedback and select an optimal feedback method.
[Additional Note 30] The system according to Additional Note 1, wherein the provision unit is configured to analyze the user's social media activity when providing feedback and propose feedback means.
[Additional Note 31] The system according to Additional Note 1, wherein the evaluation unit is configured to estimate the user's emotion and adjust the evaluation method based on the estimated emotion.
[Additional Note 32] The system according to Additional Note 1, wherein the evaluation unit is configured to analyze the user's past performance data during evaluation and select an optimal evaluation method.
[Additional Note 33] The system according to Additional Note 1, wherein the evaluation unit is configured to customize evaluation criteria based on the user's current skill level during evaluation.
[Additional Note 34] The system according to Additional Note 1, wherein the evaluation unit is configured to estimate the user's emotion and determine the priority of evaluation based on the estimated emotion.
[Additional Note 35] The system according to Additional Note 1, wherein the evaluation unit is configured to consider the user's geographic location information during evaluation and select an optimal evaluation method.
[Additional Note 36] The system according to Additional Note 1, wherein the evaluation unit is configured to analyze the user's social media activity during evaluation and propose evaluation means.

What is claimed is:

1. A system comprising: an acquisition unit configured to acquire physique data; an analysis unit configured to analyze the physique data acquired by the acquisition unit; a generation unit configured to generate an optimal playing form and fingering method based on the data analyzed by the analysis unit; a provision unit configured to provide feedback generated by the generation unit; and an evaluation unit configured to evaluate user progress based on the feedback provided by the provision unit and propose new practice methods or tasks.

2. The system according to claim 1, wherein the provision unit is configured to display feedback generated by a generative AI superimposed in AR on the user's performance.

3. The system according to claim 1, wherein the evaluation unit is configured to periodically evaluate user progress and propose new practice methods or tasks according to the skill level.

4. The system according to claim 1, wherein the acquisition unit is configured to acquire the user's physique data using a smartphone camera.

5. The system according to claim 1, wherein the analysis unit is configured to generate a user-specific profile based on the acquired physique data.

6. The system according to claim 1, wherein the generation unit is configured to analyze a user's performance video and generate an ideal playing form and fingering method.

7. The system according to claim 1, wherein the acquisition unit is configured to estimate the user's emotion and adjust the timing of acquiring physique data based on the estimated emotion.

8. The system according to claim 1, wherein the acquisition unit is configured to analyze the user's past physique data and select an optimal acquisition method.

9. The system according to claim 1, wherein the acquisition unit is configured to perform filtering based on the user's current health condition and lifestyle habits when acquiring physique data.

10. The system according to claim 1, wherein the acquisition unit is configured to estimate the user's emotion and determine the priority of physique data to be acquired based on the estimated emotion.
